(19) United States
(12) Patent Application Publication
(10) Pub. No.: US 2022/0213923 A1
(43) Pub. Date: Jul. 7, 2022

(54) ADJUSTABLE TAPERED WASHER

(71) Applicant: AGCO Corporation, Duluth, GA (US)

(72) Inventor: David Wayne O'Reilly, McPherson, KS (US)

(21) Appl. No.: 17/627,064

(22) PCT Filed: Jun. 8, 2020
(86) PCT No.: PCT/IB2020/055365

§ 371 Date: Jan. 13, 2022

Related U.S. Application Data
(60) Provisional application No. 62/875,018, filed on Jul. 17, 2019.

(51) Int. Cl. F16B 43/02; F16H 7/12

(52) U.S. Cl. CPC F16B 43/02; F16H 7/12

(57) ABSTRACT

In one embodiment, a washer assembly, comprising: plural washers adjacent each other, each having a tab and a tapered body of a defined angle, wherein relative adjustment of the tabs corresponds to a composite angle range from zero to twice the defined angle.

### TECHNICAL FIELD

The present disclosure is generally related to manufacturing, and, more particularly, mechanical assemblies to facilitate a manufacturing process.

### BACKGROUND

Mechanical assemblies, especially those involving the installation of precision parts or sub-assemblies onto welded structures, often require geometrical angular adjustments or angular alignments. For some agricultural equipment companies, this is especially true with the manufacture or fabrication of multi-rib, V-belt drives, but is not limited to that application. For V-belt drives, a spring-loaded pulley is employed to maintain proper initial tension on a slack-side span between V-grooved driver and driven sheaves. Tensioner pulleys are most often non-grooved on their diameter in contact with the belt. If the pulley axis-of-rotation is perpendicular to the direction of belt travel, then the belt will not deflect and instead run true or square and maintain position on the pulley. If even a small angular misalignment exists between the axis of rotation and a normal or orthogonal direction of the chassis (e.g., hence, not perpendicular), the belt will progressively track in a direction lateral to the direction of travel. If this misalignment is sufficiently large, the belt may jump a groove on the driver and/or driven sheaves, potentially compromising the belt drive. Alignment of a pulley relative to the chassis during the manufacturing process is difficult and time consuming. The same is true for a pulley on the tight-side of a belt drive where alignment is especially important.

### SUMMARY OF THE INVENTION

In one embodiment, a washer assembly, comprising: plural washers adjacent each other, each having a tab and a tapered body of a defined angle, wherein relative adjustment of the tabs corresponds to a composite angle range from zero to twice the defined angle.

These and other aspects of the invention will be apparent from and elucidated with reference to the embodiment(s) described hereinafter.

### BRIEF DESCRIPTION OF THE DRAWINGS

Many aspects of an adjustable washer assembly and corresponding system of the present disclosure can be better understood with reference to the following drawings. The components in the drawings are not necessarily to scale, emphasis instead being placed upon clearly illustrating the principles of an adjustable washer assembly and associated system. Moreover, in the drawings, like reference numerals designate corresponding parts throughout the several views.

FIG. 1 is a schematic diagram that illustrates, in fragmentary view, an example environment in which an embodiment of an adjustable washer assembly may be used.

FIG. 2 is a schematic diagram that illustrates in fragmentary, cross-sectional view a pulley with and without misalignment to demonstrate an example misalignment and show an example location where misalignment of a pulley during manufacture may be addressed by an embodiment of an adjustable washer assembly.

FIGS. 3A-3B are schematic diagrams that conceptually illustrate the effect of the misalignment, similar to that depicted in FIG. 2, on belt tracking issues for which an embodiment of an adjustable washer assembly may be used to compensate.

FIGS. 4A-4B are schematic diagrams that illustrate in fragmentary, rear-isometric and side elevation, cut-away views, respectively, an embodiment of a system that uses an embodiment of an adjustable washer assembly to compensate for the misalignment and belt tracking issues depicted in FIGS. 2-3B.

FIGS. 5A-5C are schematic diagrams that illustrate in fragmentary, front isometric views, the progressive manufacture of portions of a pulley using an embodiment of an adjustable washer assembly.

FIGS. 6A-6C are schematic diagrams that illustrate in isometric views various configurations of an embodiment of an adjustable washer assembly.

FIGS. 7A-7B are schematic diagrams that illustrate in cross-sectional and front elevation views, respectively, a single washer of an embodiment of an adjustable washer assembly.

FIGS. 8A-8B are schematic diagrams that illustrate in cross-sectional and front elevation views, respectively, an embodiment of an adjustable washer assembly comprising a set of washers.

FIG. 8C is a diagram that illustrates a table defining example face angles based on relative tab angles of an embodiment of an adjustable washer assembly.

### DESCRIPTION OF EXAMPLE EMBODIMENTS

Certain embodiments of an adjustable washer assembly and system are disclosed that facilitate the use of geometric angular adjustments or alignments to address misalignment among components of a mechanical system. In one example environment, disclosed herein, the mechanical system comprises a belt drive system having one or more pulleys that are mounted to a chassis. In one embodiment, the adjustable washer assembly comprises plural (e.g., two (2)) identical washers, each of which has a body having a small bevel or taper angle and a tab (or equivalently, an ear or tell-tale handle). When used in sets (e.g., pairs), the relative angular position of the tabs controls a total or composite (face) angle, enabling adjustment between the pulley and the chassis to compensate for misalignment. For instance, at one extreme with tabs opposed, the individual bevel angles cancel each other for a composite angle of zero. Also, at another extreme when tabs are aligned, the composite bevel angle is twice (e.g., 2x) the individual angle. Adjustments may be made at these composite angles or anywhere in between.

Digressing briefly, current solutions to misalignment of pulleys relative to the chassis includes disassembling the pulley and grinding a bushing encompassing a pulley shaft, the bushing abutted against the chassis, to introduce a corrective angle, which may consume considerable labor hours; or alternatively, adding a plate that mounts to three threaded rods projecting from the chassis and using pairs of nuts on one or more of the rods to make adjustments to the angle, which adds cost, weight, and consumes space. In contrast, certain embodiments of an adjustable washer assembly provide a simple, low cost solution to such misalignments that also features a thin profile with low space requirements.

Having summarized various features of certain embodiments of an adjustable washer assembly of the present disclosure, reference will now be made in detail to the detailed description of an adjustable washer assembly as illustrated in the drawings. While the disclosure is described in connection with these drawings, there is no intent to limit it to the embodiment or embodiments disclosed herein. For instance, though emphasis is placed on an environment comprising belt drives, in some embodiments, an adjustable washer assembly may be used in other applications as an alternative to grinding or complicated, heavy brackets to correct for misalignments in any of a variety of mechanical systems. Further, although the description identifies or describes specifics of one or more embodiments, such specifics are not necessarily part of every embodiment, nor are all various stated advantages associated with a single embodiment. On the contrary, the intent is to cover all alternatives, modifications and equivalents included within the scope of an adjustable washer assembly as defined by the appended claims. Further, it should be appreciated in the context of the present disclosure that the claims are not necessarily limited to the particular embodiments set out in the description.

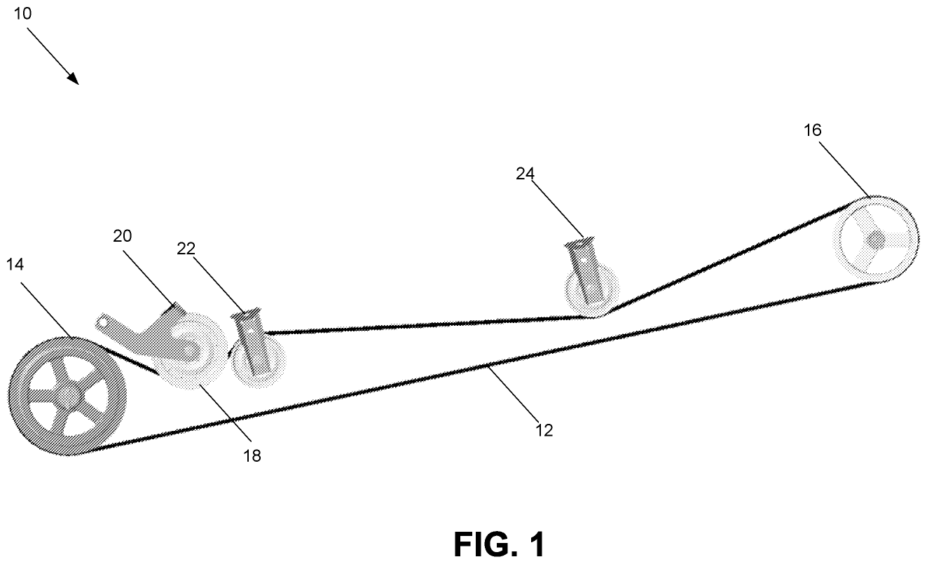

Referring now to FIG. 1, shown is a schematic diagram of an example environment 10 in which an embodiment of an adjustable washer assembly may be used. The example environment 10 comprises a belt drive system (e.g., a multi-strand (multi-rib) V-belt drive), which may be used on a combine harvester. The belt drive system may be used to run a shaker mechanism of the combine harvester or for other belt drive tasks on a combine harvester or for driving/guiding a belt on other machines. The belt drive system in this example environment 10 comprises an endless belt 12 whose movement is influenced by a driver sheave 14 on one end and guided by a driven sheave 16 on the other end. The driver sheave 14 and the driven sheave 16 each comprise V-grooves that guide the belt 12, and are fixed to, and supported by, respective shafts or mounting assemblies (not shown) operably coupled to a chassis. Further, the respective mounting assemblies for the driver sheave 14 and the driven sheave 16 tend to be fairly true (e.g., aligned, squared, orthogonal) with the chassis. In between the driver sheave 14 and the driven sheave 16 is a tensioner pulley 18 and coupled spring-loaded tensioning assembly 20 (e.g., a pivoting or floating tensioning arm, with pivot shaft and spring not shown) on a slack-span of the belt 12, a fixed position idler pulley 22 on the slack span of the belt 12, and a fixed position idler pulley on a tight/driving span of the belt 12, all of which are supported by a chassis. In general, the tensioner pulley 18 and tensioning assembly 20 are configured to provide tension to the belt 12. The belt tension, along with the magnitude for the belt wrap (angle), results in a reaction force (radial force) applied to the pulley 18 and its supporting structure. The idler pulleys 22 and 24 are configured to guide the belt between the driver sheave 14 and the driven sheave 16, and are typically comprised of low cost, sheet metal assemblies that are generally not grooved. One or more of the pulleys 18, 22, and 24 tend to be misaligned relative to the chassis (e.g., not true, square or orthogonal to the chassis). That is, a pulley axis of rotation is not square to the direction of belt travel.

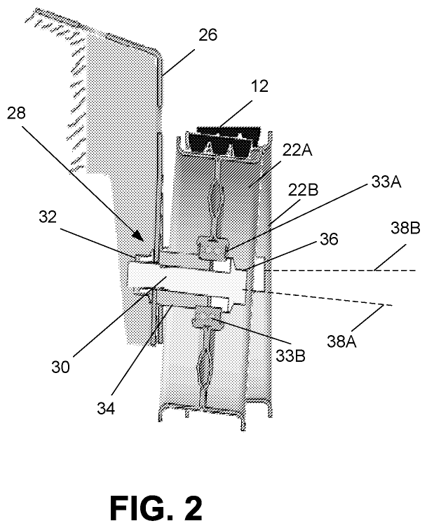

FIG. 2 illustrates a cross-sectional, side elevation view of the idler pulley 22 with (deflected, 22A) and without misalignment (undeflected 22B), which are also shown here to illustrate a location for certain embodiments of an adjustable washer assembly. It should be appreciated by one having ordinary skill in the art that any one or more (e.g., all) of the pulleys 18, 22, or 24 may have misalignment issues during the manufacturing process, and that the selection of the idler pulley 22 is for illustrative purposes, with similar applicability to the other pulleys. The idler pulley 22 also provides a good choice for illustrating how certain embodiments of an adjustable washer assembly compensates for a source or sources of misalignment, given the direction of rotation and the long entry span for this particular idler pulley 22, as described below. A source of misalignment may be static (e.g., due to manufacturing error) and/or elastic (e.g., due to belt load and lack of stiffness in the supporting structure), and certain embodiments of an adjustable washer assembly may compensate for either or both sources of misalignment. Shown is the belt 12 that is guided along the idler pulley 22 in known manner. Also shown is a chassis 26 to which the belt drive system is mounted. The chassis 26 comprises an opening 28 through which a mounting assembly for the idler pulley 22 is inserted and secured to the chassis 26. The mounting assembly comprises a shaft 30 that enables rotation of the pulley 22, the shaft 30 inserted through the opening 28 and mounted to an internal surface of the chassis 26 by a securing member (e.g., nut) 32. Cylindrically surrounding or enclosing the shaft 30 is a bushing 34. The bushing 34 is clamped or tightened against the outside or face surface of the chassis 26 via a securing member (e.g., nut) 36 at the end of the shaft 30 opposing the securing member 32. Also shown are known bearing structures 33 (e.g., 33A, 33B) of the idler pulley 22. As depicted in FIG. 2, there exists a slight misalignment between the pulley 22A and the chassis 26, which is revealed by the skewed angle of the pulley 22A relative to the chassis 26. Note the comparison between the pulley 22A with misalignment, and the pulley 22B without misalignment. The misalignment causes the belt 12 to wander and not track true. In certain embodiments of an adjustable washer assembly, the adjustable washer assembly is arranged between the bushing 34 and the outside surface or face of the chassis 26 to compensate for the misalignment. Stated otherwise, the adjustable washer assembly compensates for the belt force and resultant deflection arising from the misalignment.

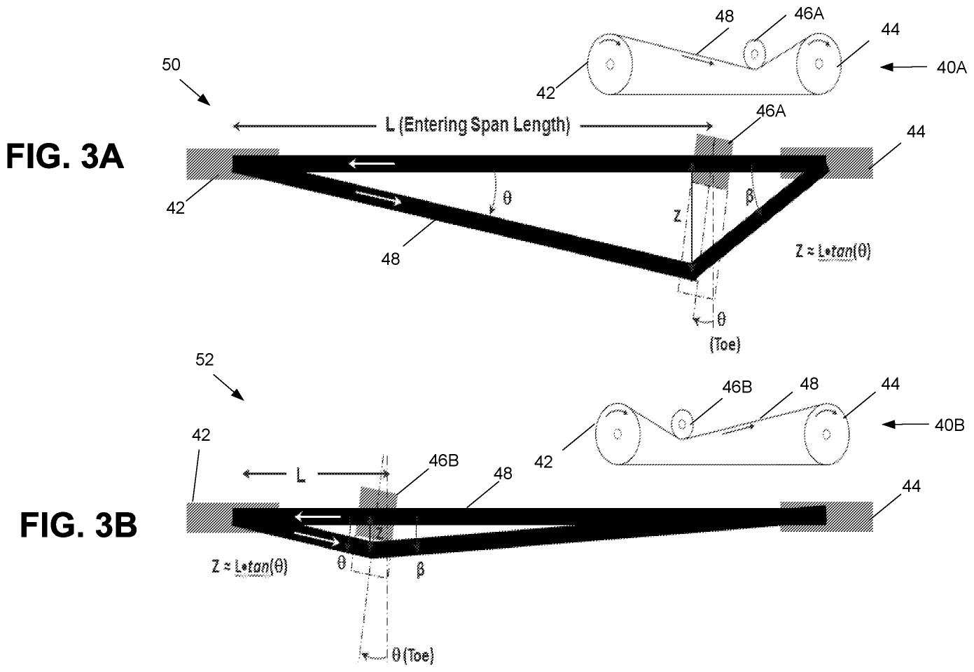

Explaining misalignment that certain embodiments of an adjustable washer assembly is intended to address, attention is directed to FIGS. 3A-3B, which conceptually illustrate the effect of a misalignment, similar to that depicted in FIG. 2, on belt tracking issues for which an embodiment of an adjustable washer assembly may be used to compensate. In FIG. 3A, a belt drive system 40A is shown, with similar functionality to the belt drive system shown in FIG. 1. The belt drive system 40A comprises a driver sheave 42 and a driven sheave 44, with a tensioner pulley 46A arranged in between, and an endless belt 48 that is driven or guided among the aforementioned pulleys/sheaves. Referring to the accompany diagram 50 immediately beneath the depiction of the belt drive system 40A, shown is an overhead, exaggerated representation (exaggerated for illustration) of the misalignment of the tensioner pulley 46A, similar to that shown in FIG. 2, and its effect on belt travel based on certain factors. For instance, the effect of misalignment on belt tracking is a function of the entry span relative to the exit span. Shown in the diagram 50 of FIG. 3A is the entering span length (L) between the driver sheave 42 and the tensioner pulley 46A, and the misalignment of the tensioner pulley 46A represented by a toe angle error, e (theta). The diagram 50 reveals that, with the misalignment, a long entry span followed by a short exist span (between the tensioner pulley 46A and the driven sheave 44 in this example) results in a large displacement (z) and a large exiting angle, β (beta), which in turn leads to high potential belt tracking issues. In other words, the belt 48 tends to run perpendicular to the pulley axis of rotation. Thus, in the presence of misalignment, the belt spirals in a direction towards a perpendicular track relative to the axis of rotation, such that the belt 48 may run off track (especially for tensioner pulleys that are unconstrained by the absence of grooves). In particular, because of this long span, the belt 48 goes off center or out of plane a relatively large distance, where recovery occurs over a short span or distance, which tends to cause the belt 48 to run off track.

In FIG. 3B, shown is the belt drive system 40B with the tensioner pulley 46B positioned closer to the driver sheave 42. In this case, and referring to diagram 52 immediately beneath the depiction of the belt drive system 40B, a relatively shorter entry span (L) is shown compared to the depiction in diagram 50, and a relatively longer exit span is also shown. In the case of a short entry span plus a long exit span, there is a small displacement (z) and a small exiting angle β (beta), which results in a lower potential for tracking issues. That is, with a short entry span, the belt 48 tends to run perpendicular to the pulley 46B, but does not travel very far (small z). Thus, recovery is long and fairly gentle (over the long exit span). It is noted that, with the same angle of toe error, the entry span relative to the exit span is an important indicator of the potential for belt tracking issues. Conventional solutions to the misalignment, as indicated above, involved adjustments to the toe angle by grinding components (or by the less labor-intensive act of bending components) of the pulley mounting assembly to induce a corrective angle, which may be a labor-intensive solution. Certain embodiments of an adjustable washer assembly make adjustments to the toe angle in a simpler, more cost-effective way.

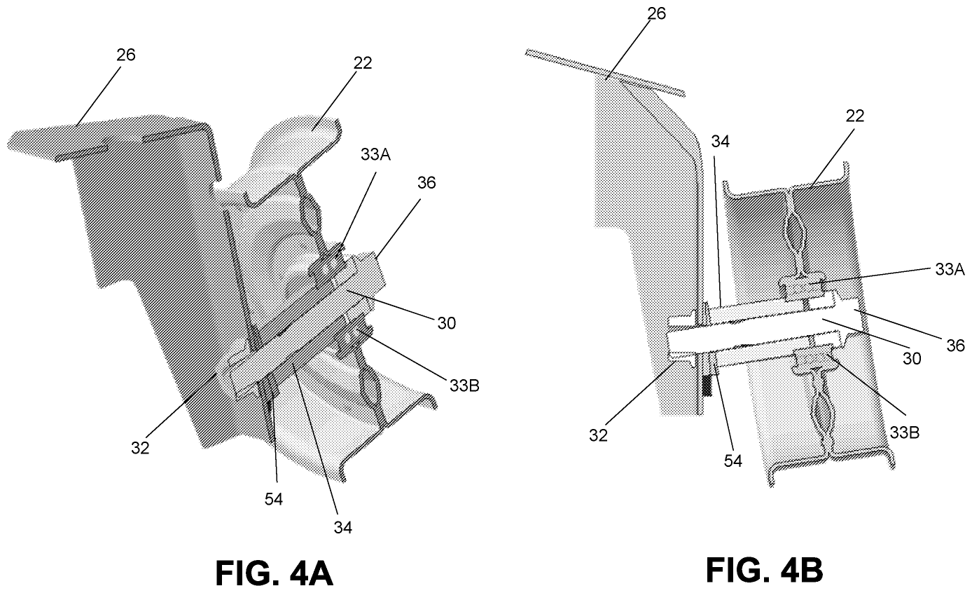

Referring now to FIGS. 4A-4B, shown are various cut-away views that demonstrate the arrangement of certain embodiments of an adjustable washer assembly that correct for the misalignment of a pulley, and in this example, the idler pulley 22 (shown in cut-away, without the belt) described in association with FIG. 2. It should be appreciated that the adjustable washer assembly may be used with similar applicability to correct or compensate for misalignment for the other pulleys 18 and/or 24 of FIG. 1, or for the tensioner pulley 46 of FIGS. 3A-3B, and that the focus on idler pulley 22 is for illustrative purposes and convenience of explanation. As shown in rear-isometric and side-elevation, cut-away views, respectively, in FIGS. 4A-4B, the idler pulley 22 is coupled to the chassis 26 via a pulley mounting assembly comprising the shaft 30 that is cylindrically surrounded or enclosed by the bushing 34 and secured to the chassis 26 at each end by securing members 32 and 36, and the bearing structures 33A and 33B, as similarly described above. However, an additional component of the pulley mounting assembly is introduced in FIGS. 4A-4B in the form of an embodiment of an adjustable washer assembly 54. As depicted in FIGS. 4A-4B, the adjustable washer assembly 54 is arranged at an interface between the bushing 34 and an outside or external (front face) surface of the chassis 26, and in this embodiment, comprises plural (e.g., a set or pair of) washers that have a tapered or beveled body and that are stacked adjacent each other and arranged or rotated in a manner that provides a composite angle that offsets the toe angle error present due to misalignment of the pulley 22 relative to the chassis 26.

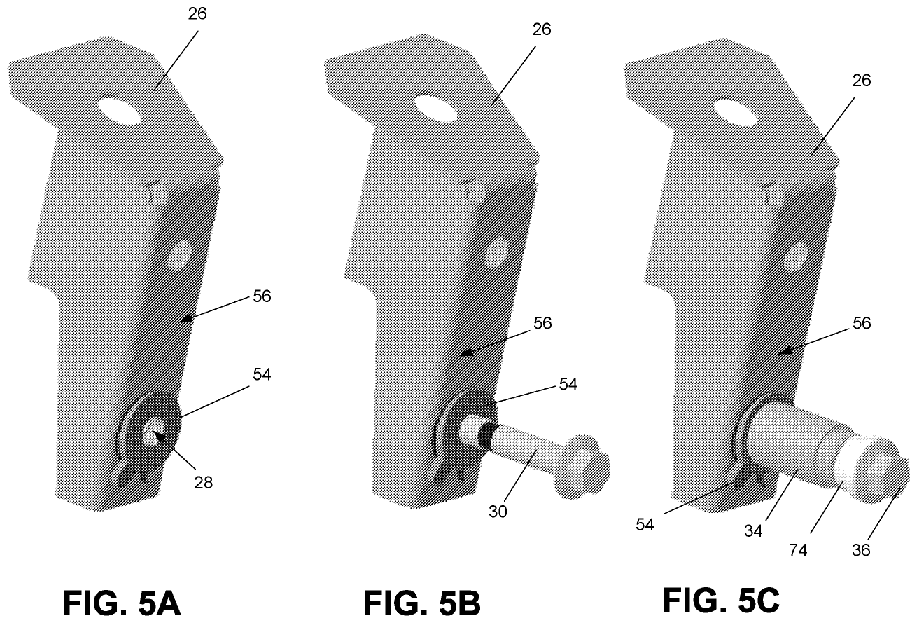

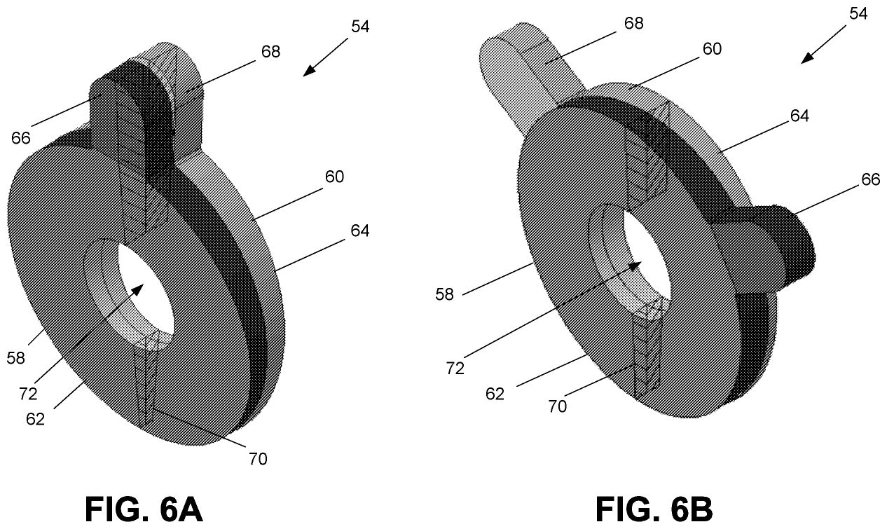

FIGS. 5A-5C provide a further illustration of various stages of manufacture of certain portions of the pulley mounting assembly using an embodiment of an adjustable washer assembly 54. Referring to FIG. 5A, shown is a front face 56 (external or outside surface) of the chassis 26, with the adjustable washer assembly 54 adjacent to (abutted against) the front face 56 and centered over the opening 28 proximal to a lower portion of the front face 56. With continued reference to FIG. 5A, attention is directed also to FIGS. 6A-6C. The adjustable washer assembly 54 comprises a pair of separate, stacked or adjacent tapered first and second washers 58, 60. Note that in some embodiments, the adjustable washer assembly may have more than two washers. The first tapered washer 58 comprises a round body 62. Likewise, the second tapered washer 60 comprises a round body 64. The first tapered washer 58 comprises a tab 66, and similarly, the second tapered washer 60 comprises a tab 68. The tabs 66, 68 serve both as handles to achieve a relative rotation angle and as a geometric visual reference. In one embodiment, the tabs 66, 68 comprise material added to the respective round bodies 62, 64. Also shown in FIGS. 6A-6C is a schematic representation 70 of the taper for each washer, 58, 60, and how the collective angle of the taper faces are adjusted based on the relative tab configuration. In FIG. 6A, the tabs 66 and 68 are exactly aligned (zero degree relative tab angle), resulting in the maximum composite (face) angle (e.g., twice the individual taper angle). In FIG. 6B, the tabs 66 and 68 are one hundred-twenty (120) degrees apart, resulting in a composite (face) angle of half of the maximum composite angle. In FIG. 6C, the tabs 66 and 68 are one hundred eighty (180) degrees apart, resulting in a composite (face) angle for the tapered washers of zero (0) degrees. Thus, toe angle errors ranging from large to small are respectively compensated by relative tab angles ranging continuously (anywhere) from zero degrees to one hundred eighty degrees.

Note that each washer 58, 60 comprises a central opening 72 that enables the shaft 30 to be inserted through the openings 72 and opening 28 (co-aligned with opening 72) of the chassis 26, as depicted in FIG. 5B. FIG. 5C shows the pulley mounting assembly with the bushing 34 cylindrically surrounding the shaft 30 and abutted against the adjustable washer assembly 54 via forces applied to the bushing 34 through adjustment of the securing member 36 acting directly or indirectly (e.g., through another bushing or spacer 74) on the bushing 34. The appropriate spacing of tabs 66, 68 needed to compensate for the misalignment (e.g., toe error) is achieved via the resultant composite angle. As shown in FIG. 5C, the bushing 34 is inserted over the shaft 30 and the adjustable washer assembly 54 is tightened against the chassis 26 via a torque applied to the securing member 36.

Though the adjustable washer assembly 54 is illustrated with washers 58 and 60 having a tapered, round body 62 and 64, respectively, in some embodiments, the tapered bodies 62, 64 may be of another geometry, such as square, hexagonal, etc. In some embodiments, the taper is constrained to the body 62, 64, though in some embodiments, the tabs 66, 68 may also be tapered. In some embodiments, the adjustable washer assembly 54 may use plural washers, each of a different body geometry.

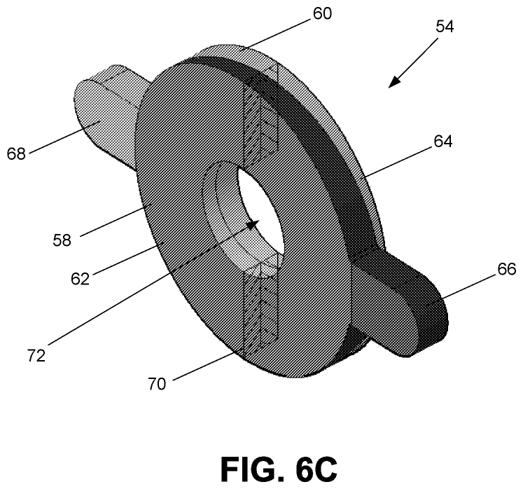

FIGS. 7A-7B are schematic diagrams that illustrate in cross-sectional and front elevation views, respectively, a single washer 76 of an embodiment of an adjustable washer assembly. The washer 76 is shown with some example dimensions (in millimeters) for illustrative purposes. It should be understood by one having ordinary skill in the art that these dimensions may differ depending on the particular mechanical system specifications serving as the environment for an embodiment of an adjustable washer assembly. In this example, the washer 76 comprises a tab 78 and round body 80, the round body comprising a central opening 82 (e.g., round in this example, but not limited to this geometry). In this embodiment, the taper begins at the juncture between the tab 78 and the body 80, and has an angular dimension of 0.50 degrees. The thickness of the washer 76 at the tab is approximately 1.0 millimeters, with the thickness at the end of the taper at approximately 0.616 millimeters.

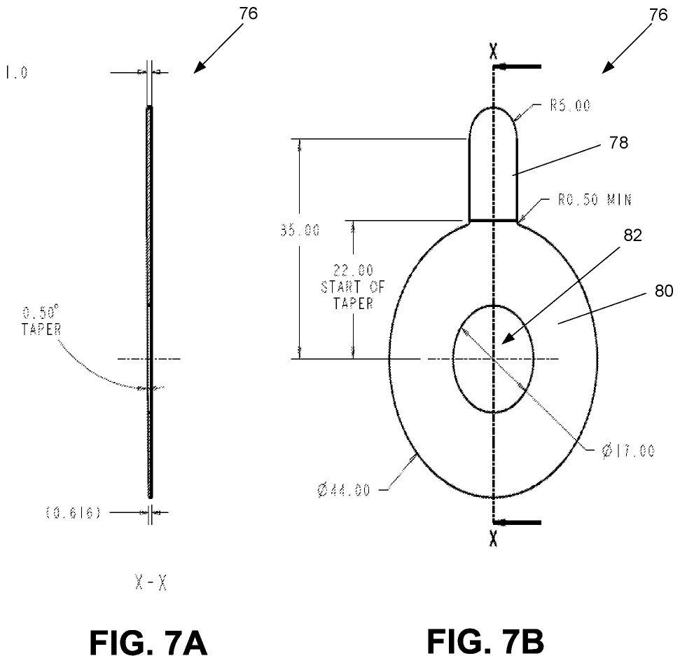

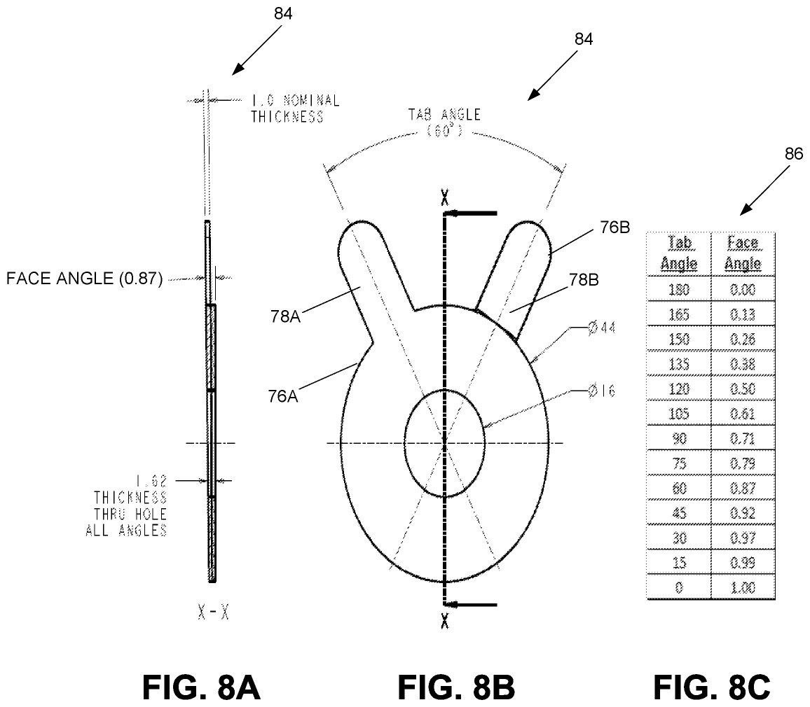

FIGS. 8A-8B are schematic diagrams that illustrate in cross-sectional and front elevation views, respectively, an embodiment of an adjustable washer assembly 84 comprising a pair of washers 76A, 76B adjacent each other. In one embodiment, the washers 76 (76A, 76B) are each of the same dimension and shape as the washer 76 depicted in FIGS. 7A-7B. As shown, the washers 76A, 76B are adjacent to each other, with adjustments in the tab angle made to enable adjustments in the composite or face angle, as depicted by table 86 in FIG. 8C. That is, table 86 proscribes a composite or face angle based on the relative tab angle. For instance, and consistent with the description of tab angles versus face angles described in association with FIGS. 6A-6C, with the tabs 78A and 78B having a relative tab angle of one hundred eighty (180) degrees, the face angle is zero degrees, whereas tab angles of one hundred twenty degrees (as depicted in FIG. 8B) and zero degrees (exactly aligned) results in respective face angles of one half and twice the tapered angle (two times 0.50 degrees as shown in FIG. 7A). The table 86 further shows the various or continuous gradations in face or composite angle, enabling fine control of angular alignment during final the final stages of manufacture (e.g., final assembly) with full adjustability of taper angle (e.g., anywhere from zero to one degrees in the example depicted in FIG. 8C).

Certain embodiments of an adjustable washer assembly correct for misalignment during the manufacturing process by enabling continuous, controllable and predictable adjustment of a taper angle. Since the washers are relatively thin, the adjustable washer assembly may be introduced into the manufacturing process without excess dimensional disruption. Further, the shallow angles involved render the tapered washer set self-locking under clamp load such that the angle will not change. Flexibility and/or adaptability is yet another feature, since the composite angle may be re-adjusted as conditions change. In some embodiments, the adjustable washer assembly may be manufactured using a coining or stamping process to keep the manufacturing cost low and simple, though not limited to these types of manufacturing processes. Further, the washers may be manufactured for any range of angular adjustment (e.g., 0-1 degrees, 0-2 degrees, 0-3 degrees, etc.) and may be used in sets or pairs of individual washers or in multiples of three or more in some embodiments.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. Note that various combinations of the disclosed embodiments may be used, and hence reference to an embodiment or one embodiment is not meant to exclude features from that embodiment from use with features from other embodiments. In the claims, the word “comprising” does not exclude other elements or steps, and the indefinite article “a” or “an” does not exclude a plurality. Any reference signs in the claims should be not construed as limiting the scope.

1. A washer assembly, comprising:
plural washers adjacent each other, each having a tab and a tapered body of a defined angle, wherein relative adjustment of the tabs corresponds to a composite angle range from zero to twice the defined angle.

2. The washer assembly of claim 1, wherein each of the tapered bodies comprise a central opening.

3. The washer assembly of claim 1, wherein a composite angle of zero corresponds to one of the tabs one hundred eighty degrees apart from the other of the tabs.

4. The washer assembly of claim 1, wherein the composite angle of twice the defined angle corresponds to each of the tabs exactly aligned and adjacent each other.

5. The washer assembly of claim 1, wherein a quantity of the plural washers is two.

6. The washer assembly of claim 1, wherein a quantity of the plural washers is more than two.

7. The washer assembly of claim 1, wherein each of the tabs is un-tapered.

8. The washer assembly of claim, wherein each of the plural washers are comprised of stamped or coined metal.

9. The washer assembly of claim 1, wherein each of the plural washers comprises any one of a plurality of body geometries.

10. A system, comprising:
a chassis comprising an opening;
a shaft inserted through the opening and operably coupled to the chassis;
a bushing cylindrically surrounding the shaft;
a pulley mounted to the bushing and the shaft; and
a washer assembly according to any preceding claim arranged between the bushing and the chassis, the washer assembly serving to compensate for misalignment of the pulley relative to the chassis that is present without the washer assembly.

11. The system of claim 10, further comprising a securing member coupled to the shaft and that is adjustable to clamp the plural washers between the bushing and the chassis.

12. The system of claim 10, wherein the shaft comprises an arm pivot shaft operably coupled to the pulley, the pulley comprising a tensioner pulley.
